(19) United States
(12) Patent Application Publication
(10) Pub. No.: US 2004/0090170 A1
(43) Pub. Date: May 13, 2004

(54) Filter for plasma display panel and method of manufacturing the same

(76) Inventors: Jun-Kyu Cha, Seoul (KR); Dong-Gun Moon, Suwon-city (KR); Kwi-Seok Choi, Suwon-city (KR); Dong-Sik Zang, Suwon-city (KR); Hyun-Ki Park, Seoul (KR); Kyu-Nam Joo, Seoul (KR); Chaun-Gi Choi, Suwon-city (KR); Myun-Gi Shim, Seoul (KR)

Correspondence Address: Robert E. Bushnell, Suite 300, 1522 K Street, N.W., Washington, DC, 20005-1202, US

(21) Appl. No.: 10/698,425

(22) Filed: Nov. 3, 2003

(30) Foreign Application Priority Data
Nov. 6, 2002 (KR) 2002-68365

(51) Int. Cl. H01J 1/62; H01J 63/04

(52) U.S. Cl. 313/489

(57) ABSTRACT

A filter for a plasma display panel and a method of manufacturing the novel filter. The filter is made up of a transparent substrate, a patterned conductive material formed on one side of the substrate, a negative photoresist with additives patterned to complement the metal pattern, the additives including a dye, a pigment and an additive to prevent reflection of external light. The method includes forming the metal pattern on the substrate, and using the metal pattern as a photo mask for patterning a layer of photoresist to complement the metal pattern.

### CLAIM OF PRIORITY

This application makes reference to, incorporates the same herein, and claims all benefits accruing under 35 U.S.C. §119 from an application entitled “FILTER FOR PLASMA DISPLAY PANEL AND METHOD OF MANUFACTURING THE SAME” earlier filed in the Korean Intellectual Property Office on 6 Nov. 2002 and thereby duly assigned Serial No. 2002-68385.

### BACKGROUND OF THE INVENTION

1. Field of Invention

The present invention relates to a filter for a plasma display panel and a manufacturing method for making the filter, and more particularly, to a filter for a plasma display panel having a plated mesh pattern for blocking the electromagnetic waves on a surface of a filter substrate, and having a negative photoresist pattern containing additives to avoid reflections of near infrared, neon light, and external light.

2. Description of the Related Art

Conventionally, a plasma display panel is used for displaying a picture by using a plasma discharging phenomenon. A plasma discharge occurs when a direct or alternate voltage is applied between electrodes of the plasma display panel, and then, resulting in an infrared ray accompanying in the plasma discharging phenomenon causing to a fluorescent substance to emit light.

A filter is disposed on an outer surface of such a plasma display panel. The filter performs a few important functions in connection with the operation of the plasma display panel. For example, electromagnetic waves generated when the plasma display panel is working are absorbed by a conductive layer in the composition of the filter, and are electrically grounded. Since the electromagnetic waves are harmful to a human body, the conductive layer for blocking the electromagnetic waves prevents the harmful waves from reaching a user in the vicinity of the plasma display panel. In addition, electromagnetic interference (EMI) radiation including RF radio frequency waves are filtered out. Among other things, these waves could disrupt wireless devices such as radios, television sets and cordless phones in the vicinity of a functioning plasma display panel if these waves were not filtered out.

Also, a material coated on the filter absorbs the near infrared rays radiated by the plasma display panel and neon light and rays having a wavelength of about 590 nm. In order to avoid a malfunction of a remote controller when operating the plasma display panel or other electronic devices located around the display, it is desirable to cut off (or block or filter out) these near infrared rays. In addition, it is also preferable to filter out the neon light to improve the quality of an image displayed on the plasma display panel. Neon light is produced in the plasma display panel due to gas discharge. Filtering out this neon light improves the quality of the image. As with many other electronic devices, it is desirable to filter out other unwanted electromagnetic waves, such as RF waves to prevent interference with wireless devices. It is also desirable to filter out other unwanted electromagnetic waves. Also; in order not to degrade the image by reflection of external light, a means for preventing external light from being reflected is mounted on an outer surface of the filter. External light means light in the room and not light generated by the plasma display.

The foregoing method of making the electromagnetic wave shielding layer has a drawback in that the metal mesh, after being formed, must be then attached to the substrate. This attachment process is very risky as the mesh can be easily damaged when attaching it to the substrate. Since, the metal mesh is a very thin layer, handling thereof requires utmost care. However, in spite of carefully handling the metal mesh, the thin layers are easily damaged. Also, the method has another drawback in that it is time consuming and expensive due to the manufacturing of the electromagnetic wave shielding layer itself and the operation of attaching the pretreated films on the front and on back surface of the substrate. Therefore, what is needed is a design for a filter and a method of making the filter that produces an effective filter for the plasma display panel and that the method of making is simple, reliable and inexpensive.

### SUMMARY OF THE INVENTION

It is therefore an object of the present invention to provide an improved design for a filter for a plasma display panel.

It is also an object to provide a filter for a plasma display panel that is simple, easy and inexpensive to manufacture with a low failure rate during manufacture.

It is also an object of the present invention to provide a filter for a plasma display panel that filters out harmful electromagnetic radiation before it reaches a viewer.

It is also an object of the present invention to provide a filter for a plasma display panel that filters out near infrared radiation therefore preventing the plasma display panel from degrading the performance of remote control devices in the vicinity of the plasma display panel.

It is still an object of the present invention to provide a filter for a plasma display panel that filters out neon light from the plasma display in order to improve image quality of the plasma display unit.

It is further an object of the present invention to filter out RF radiation so that the functioning plasma display unit does not interfere with wireless devices near the functioning plasma display unit.

It is further an object of the present invention to provide a filter for a plasma display panel that prevents light from within the room from reflecting off the display.

It is still an object of the present invention to provide a method of making a filter for a plasma display panel that is inexpensive and reliable.

These and other objects can be achieved by a filter for a plasma display having a substrate made out of plastic or glass, having a metallic mesh on one side of the substrate and attached to the substrate, with negative photoresist disposed between gaps in the metallic mesh. The metal mesh is used to block harmful and unwanted electromagnetic waves from emanating from the functioning plasma display. These filtered harmful waves can be RF EMI as well as other electromagnetic waves. The negative photoresist is formed from a material from transparent acryl group or phenol group. The negative photoresist contains additives, including a dye, a pigment and an additive that prevents external light from being reflected. The dye is used to block infrared waves having a wavelength near that of remote controllers, 590 nm or neon light. The dye is preferably an organic compound of an imonium group or a phthalocyanin group. The pigment is preferably an organic compound of the imonium group. The pigment is also used to block near infrared light and neon light produced in the plasma display. The material for preventing the reflection of external light is preferably a metal powder or an inorganic oxide such as TiO₂ or In₂O₃.

The above structure can be made by the following method. At first, a patterned seed layer of a metal mesh is formed on one side of the substrate. The metal is preferrably sputtered on, then patterned and etched using photoresist. Next, a layer of negative photoresist having the above additives is applied onto the side of the substrate having the metal seed mesh pattern. The negative photoresist is patterned by shining light through the substrate. The patterned seed metal serves as a mask in the patterning of the negative photoresist. The exposed negative photoresist between the metal mesh, is hardened while negative photoresist on the metal is left soft and is then removed to expose the metal. Thus, the patterned negative photoresist pattern complements the metallic pattern. Then, the metal mesh pattern is made thicker by electroplating resulting in the final structure. The patterned negative photoresist and the metal mesh are anywhere from 1 to 50 microns thick.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a general perspective view of a plasma display panel;

FIGS. 2A through 2E are general cross-sectional views for describing the method of manufacturing a filter for a plasma display panel, according to the principles of the present invention; and

FIG. 3 is a flow chart diagram illustrating the sequential steps of the method of manufacturing the filter for a plasma display panel, according to the principles of the present invention.

### DETAILED DESCRIPTION OF THE INVENTION

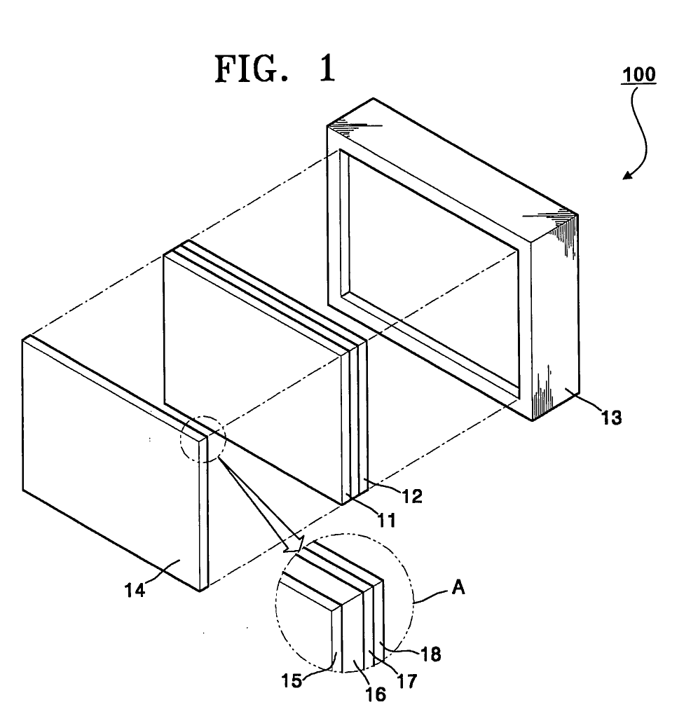

FIG. 1 is a general perspective view of a plasma display device 100. Referring to FIG. 1, the plasma display device 100 is made up of a image displaying panel 11 a printed circuit substrate 12, which is placed on the backside of the panel 11 and has an electronic device for operating the panel, a filter 14 placed on the front face of the panel 11 and a case 13 accommodating filter 14 therein.

As illustrated in the magnified drawing A in FIG. 1, the filter 14 is made up of a substrate 16, a film 15 for preventing external light from being reflected attached to a surface of the substrate 16, an electromagnetic wave shielding layer 17 placed on an opposite side of the substrate 16 and a film 18 for blocking near infrared rays and neon light, attached to the electromagnetic wave shielding layer 17. The electromagnetic wave shielding layer 17 is metallic and is electrically grounded by an electrical connection with the case 13.

With regard to the filter 14, the substrate 16 is glass or plastic. The electromagnetic wave blocking layer 17 is made of a conductive thin film of copper by pattern etching in a predetermined form, and then, it is treated with a black oxide film to enhance contrast and is then attached on to substrate 16. Alternatively, the electromagnetic wave blocking layer 17 is made of a conductive woven fiber and is then attached to the substrate 16. In order to cut off the near infrared ray and neon light, a film 18 treated with a color for blocking light in a specific wavelength range is used.

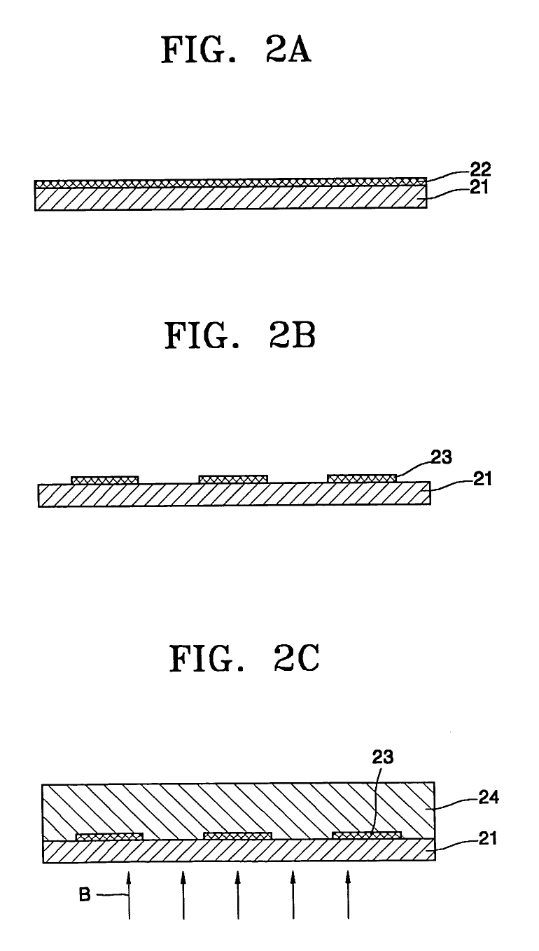

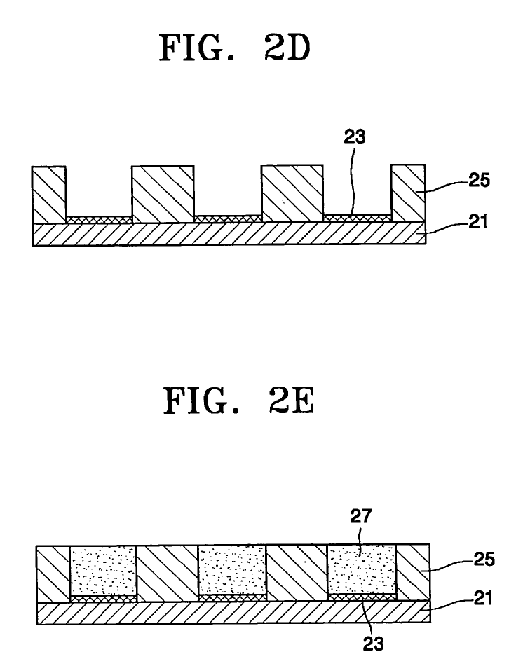

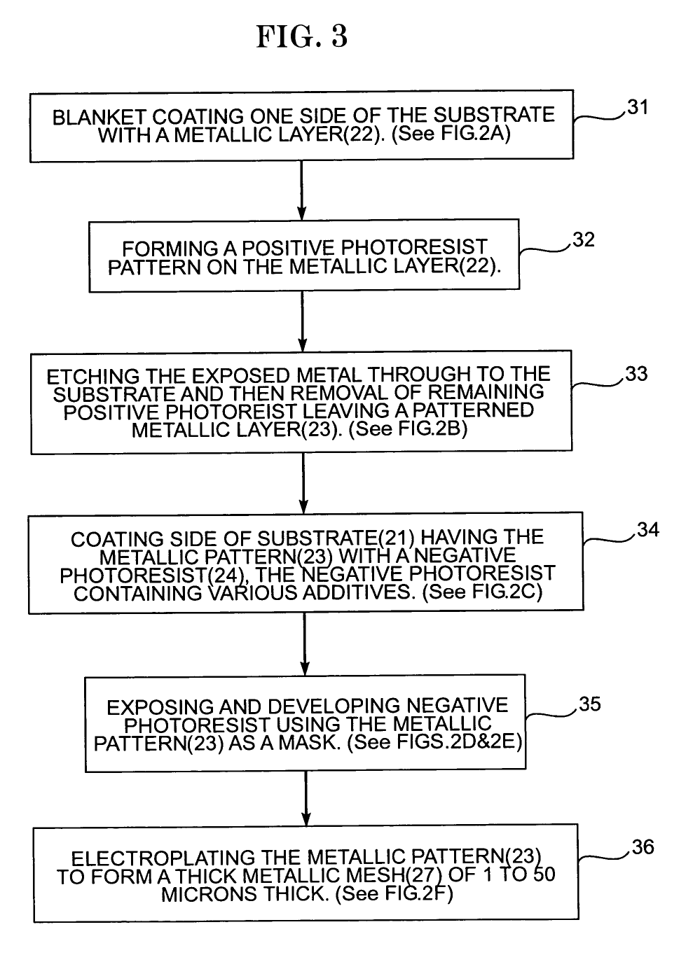

FIGS. 2A through 2E are general cross-sectional views for describing the method of manufacturing a filter for a plasma display panel according to the principles of the present invention. FIG. 3 is a block diagram illustrating the sequential steps of the method of manufacturing the filter for a plasma display panel according to the principles of the present invention. FIGS. 2A through 2E and FIG. 3 will all now be discussed together.

Referring to FIG. 2A, the whole surface of a substrate 21 is coated with a layer of conductive material 22 for manufacturing the electromagnetic shielding part of the plasma filter. The conductive layer 22 is metallic, and preferably made of a material such as titanium or silver (Ag). The conductive layer 22 will act as a seed layer in an electroplating process to follow. Since the substrate 21 is made of glass or plastic, the formation of a metal layer on the substrate layer so that the metal layer will stick to and not delaminate from the substrate is not easy. Therefore, a coating layer acting as a seed has to be formed thereon before the thickness of the layer can be increased by electroplating. Coating the substrate 21 by the conductive layer 22 can be performed by a commonly used method such as a sputtering method. An operation depicted in FIG. 2A corresponds to step 31 in the flow chart of FIG. 3.

Referring to FIG. 2B, a conductive material pattern 23 with a predetermined pattern is formed form the blanket conductive layer 22. The conductive material pattern 23 is formed by a method including coating a positive photoresist, an exposure process using a patterned mask, a development process, an etching process and a photo resist removal process. That is, the positive photoresist is first coated on the whole surface of the conductive layer 22. Then, the positive photoresist is exposed to light through a mask having a predetermined pattern to expose portions of the positive photoresist to form the desired pattern. Thereafter, the exposed portion of the positive photoresist is removed via the developing process. After removing the exposed portion of the positive photoresist, the process of forming the positive photoresist pattern is completed. This method of forming the positive photoresist pattern corresponds to step 32 in FIG. 3.

Next, a portion of the conductive layer 22 is removed via the etching process. An etch is performed on the conductive layer with a pattern of positive photoresist formed thereon. Areas of the conductive metal layer not covered by the photoresist are etched all the way to the substrate while portions of the conductive layer that are covered by photoresist are not touched by the etching process. After the etching process, the patterned positive photoresist is removed, leaving only the conductive material pattern 23 on the substrate 21 as depicted in FIG. 2B. This process corresponds to step 33 in FIG. 3.

FIG. 2C is a cross-sectional view illustrating that a negative photoresist 24 is coated on the side of the substrate 21 having the conductive pattern 23. The negative photoresist 24 is made of a material from transparent acryl group or a phenol group. Negative photoresist contains a number of additives, including (1) a dye, (2) a pigment and (3) a material for preventing external light from being reflected off the plasma display panel. It is preferable that all three of these additives are included in the negative photoresist, but the present invention is not limited thereto. The dye is preferably an organic compound of the imonium group or the phthalocyan group. The dye is for blocking out near infrared radiation produced by the plasma display so that it does not interfere with remote control devices. In addition, neon light and light of about 590 nm produced by the functioning plasma display panel is blocked by the dye in the negative photoresist. The pigment is preferably an organic compound of the imonium group. The pigment is also used to block out the near infrared light. The material for preventing external light from being reflected is preferably a metal powder or an inorganic metal oxide such as TiO₂ or In₂O₃. The step of coating the conductive material pattern 23 on substrate 21 with the negative photoresist 24 containing the additives corresponds to step 34 in FIG. 3.

Unlike positive photoresist, unexposed portions (as opposed to exposed portions in positive photoresist) of negative photoresist are removed during developing. In the present invention, the exposing is preformed by illuminating the side of the substrate 21 that is opposite toe side containing metal pattern 23 or negative photoresist 24. This illuminating light goes through the substrate 21 and through the negative photoresist 24 in spots where there is no metal 23 to block the light. In other words, negative photoresist 24 hardens when it is exposed to light. Therefore, when light is radiated from the opposite side of the negative photoresist coated of the substrate 21 as indicated by the arrow B in FIG. 2C, the negative photoresist behind the conductive material pattern 23 will not harden and thus be removed when developed. On the contrary, portions of the negative photoresist 24 not covered by the conductive material pattern 23 will harden and thus not be removed when developed. That is, when light is radiated to the negative photoresist 24, the conductive material pattern 23 serves as a mask. The resulting patterned negative photoresist 25 complements the metal pattern 23.

FIG. 2D illustrates a completed state of the negative photoresist 25 after exposure and developing. After exposing the blanket negative photoresist 24 to light as described in FIG. 2C, the unhardened (or unexposed) portions of the negative photoresist 24 are removed as depicted in FIG. 2D during developing. Accordingly, only a negative photoresist pattern 25 remains on the substrate 21. The negative photoresist pattern 25 does not overlapping on the conductive material pattern 23. Instead, the resist pattern 25 complements the metal pattern 23. This resist pattern 25 remains on the final structure of the filter. The above developed pattern corresponds to step 35 in FIG. 3.

After the negative photoresist is developed thus exposing the metal pattern 23, the metal pattern 23 is thickened into a mesh by electroplating. FIG. 2E illustrates the thickened metal pattern 23 with the plate mesh 27, corresponding to step 36 in FIG. 3. The substrate 21 formed with the conductive material pattern 23 and a negative photoresist pattern 25 thereon as illustrated in FIG. 2D are immersed in an electrolytic bath for performing the electrical plating. After the electrical plating is finished, a plated mesh 27 is formed on the conductive material pattern 23 and fills spaces between the negative photoresist pattern 25. A height and a width of the formed metal pattern 23 and plated mesh 27 are preferably from 1 to 50 μm. The metal for the electrical plating is preferably a material having a good conductivity such as silver or copper.

The filter having the configuration as depicted in FIG. 2E, together with the conductive material pattern 23 and the plated mesh 27 blocks electromagnetic waves that may include RF EMI waves, and the negative photoresist pattern 25 with its additives blocks out neon light and light in a specific wavelength range and prevents the reflection of external light. That is, since the conductive material pattern 23 and the plated mesh 27 are formed of a material having a good conductivity and they are electrically grounded to the case, the electromagnetic waves generated from the plasma display panel can be conducted through the conductive material pattern 23 and the plated mesh 27 and grounded to the case. Also, the dye and the pigment contained in the negative photoresist pattern 25 block out the near infrared rays and neon light produced by the functioning plasma display, and the material for preventing external light from being reflected disperses the external light, thereby preventing the degradation of an image displayed on the plasma display panel.

The filter for a plasma display panel, according to the present invention, has a metal mesh for blocking the electromagnetic waves and a photoresist pattern for blocking light in a specific wavelength range formed safely on a surface of a substrate. By using the method of making of the present invention, a larger fraction of filters are made satisfactorily with the process of FIGS. 2A through 2E and FIG. 3 versus other processes because the metallic mesh does not have to be attached to the substrate. In other words, fewer filters have to be scraped during the production process. Therefore, the filter has high fidelity in performing its function. Particularly, unlike the design of FIG. 1, the present invention does not employ a plurality of stacked film layers. Thus, production costs are reduced using the method of FIGS. 2A through 2E and FIG. 3. Also, the method of manufacturing the filter according to the present invention has the advantage of easiness in manufacturing in comparison to other methods like that of FIG. 1.

While this invention has been particularly illustrated and described with reference to a preferred embodiment thereof, it will be understood by those skilled in the art that various changes in form and details may be made therein without departing from the sprit and scope of the invention as defined by the appended claims. The scope of the invention should, therefore, be determined with reference to the appended claims, along with the full scope of equivalents to which such claims are entitled.

What is claimed is:

1. A filter for a plasma display panel, comprising:
a substrate;
a conductive material pattern formed on the substrate;
a negative photoresist pattern, patterned on the substrate on portions not covered by the conductive material pattern to complement the conductive material pattern, the negative photoresist pattern comprising a pigment and a dye that cuts off light in a specific wavelength range, as well as a material that prevents external light from being reflected; and
a plated mesh formed on a conductive material pattern.

2. The filter of claim 1, the negative photoresist pattern comprising a material selected from the group consisting of a transparent acryl group and a phenol group.

3. The filter of claim 1, the dye comprising an organic compound selected from the group consisting of an imonium group and a phthalocyanin group, the pigment comprising an organic compound of the imonium group, the dye blocking near infrared rays.

4. The filter of claim 1, the dye comprising an organic compound selected from the group consisting of an imonium group and a phthalocyanin group, the pigment comprising an organic compound of the imonium group, the dye blocking light having a wavelength near 590 nm.

5. The filter of claim 1, the combined thickness of the conductive material pattern and the plated mesh formed thereon being in a range of 1 to 50 μm.

6. The filter of claim 1, wherein said material preventing the external light from being reflected being selected from the group consisting of a metal powder and an inorganic metal oxide.

7. A method of manufacturing a filter for a plasma display panel, the method comprising the steps of:
coating an entire surface of a substrate with a layer of a conductive material;
forming a predetermined positive photoresist pattern on the conductive material by applying the photoresist, exposing the photoresist and developing the exposed photoresist;
etching exposed conductive material;
removing said patterned positive photoresist leaving a patterned conductive material on the substrate;
coating said entire surface of the substrate having the patterned conductive material with a layer of negative photoresist that comprises a dye and a pigment that cuts off light in a specific wavelength range, the negative photoresist further comprising a material preventing external light from being reflected;
exposing the negative photoresist by illuminating said substrate from a side opposite from said surface containing said patterned conductive layer and the negative photoresist; developing the exposed negative photoresist to form a pattern exposing said patterned conductive material; and
forming a plated mesh on the exposed conductive material pattern by electrical plating.

8. The method of claim 7, wherein the negative photoresist comprises a material selected from the group consisting of a transparent acryl group and a phenol group.

9. The method of claim 7, the dye comprises an organic compound of an imonium group, and the pigment comprises an organic compound of the imonium group, the dye filtering out near infrared rays.

10. The method of claim 7, wherein the dye is an organic compound of an imonium group or a phthalocyanin group, and the pigment is an organic compound of the imonium group, the dye blocking light having a wavelength of about 590 nm.

11. A method for making a filter for a plasma display panel, comprising the steps of:
forming a patterned layer of a conductive material on one side of a transparent substrate;
applying a layer of negative photoresist on said patterned side of said substrate;
exposing a pattern in said negative photoresist by illuminating a side of said substrate opposite said patterned side;
developing said negative photoresist exposing only portions on said one side of said substrate patterned by the conductive material; and
increasing the thickness of said conductive material on said one side of said substrate by electroplating.

12. The method of claim 11, said negative photoresist forming a pattern that complements said patterned conductive material.

13. The method of claim 11, said patterned conductive material being formed by forming a blanket layer of conductive material, applying, patterning, and developing a positive photoresist layer on the blanket conductive layer and then etching the conductive layer with patterned photoresist thereon before removing the patterned positive photoresist.

14. The method of claim 13, said blanket layer of conductive material being formed by sputtering.

15. The method of claim 11, adding additives to said negative photoresist prior to said applying step, the additives serving to filter out near infrared wavelengths.

16. The method of claim 11, said patterned layer of said conductive material serves as a mask in said exposing step.

17. A filter for a plasma display, comprising:
a substrate that is transparent to light;
a conductive mesh pattern formed on one side of the substrate; and
a non conductive material disposed on said one side of said substrate at locations absent said conductive mesh.

18. The filter of claim 17, said conductive mesh and said non-conductive material having equal depths between 1 and 50 microns.

19. The filter of claim 17, said non conductive material being negative photoresist containing additives.

20. The filter of claim 17, said mesh being electrically grounded.

21. The filter of claim 17, said mesh having a grid pattern.

22. The filter of claim 17, said additives comprising a dye.
